(19) United States
(12) Patent Application Publication
(10) Pub. No.: US 2018/0235138 A1
(43) Pub. Date: Aug. 23, 2018

(54) Shank Mounted Angled Coulter Disc

(71) Applicant: P.J. Gaber & Sons Ltd., Roblin (CA)

(72) Inventor: Dwayne John Bulizuik, Roblin (CA)

(21) Appl. No.: 15/834,575

(22) Filed: Dec. 7, 2017

Related U.S. Application Data
(60) Provisional application No. 62/462,111, filed on Feb. 22, 2017.

(51) Int. Cl. A01B 15/18; A01B 5/00

(52) U.S. Cl. CPC A01B 15/18; A01B 5/00

(57) ABSTRACT

A coulter disc mounting assembly for a tillage implement supports a coulter disc thereon to be angularly offset from the forward working direction of the implement. The tillage implement typically includes a frame supporting a plurality of tool shanks thereon, each having a mounting surface adapted for mounting a respective shovel opener thereon in which the mounting surface has a width which is substantially perpendicular to the forward working direction. The disc mounting assembly has a hub with a mounting surface for fastening against the mounting surface of one of the tool shanks in which the hub supports a coulter disc thereon such that the coulter axis is oriented non-perpendicularly to the forward working direction.

This application claims the benefit under 35 U.S.C. 119(e) of U.S. provisional application Ser. No. 62/462,111, filed Feb. 22, 2017.

### FIELD OF THE INVENTION

The present invention relates to a disc mounting assembly for mounting at least one coulter disc to a respective tool shank of a tillage implement instead of a conventional shovel opener, and more particularly, the present invention relates to a disc mounting assembly for mounting the one or more coulter discs for rotation about a coulter axis which is non-perpendicular to the forward working direction of the tillage implement despite the respective tool shank being aligned in the forward working direction.

### BACKGROUND

A common type of agricultural cultivating implement includes a frame having a plurality of tool supporting shanks thereon for supporting respective cultivator tools thereon, for example shovels or chisels. The cultivator tools are used to provide an even and clean seedbed, by either creating a large horizontal swath using a shovel, or running deeply when using a chisel.

Farming today is most commonly done following “no-till” or “minimum tillage” practices in which much of the crop residue from a previous year's crop is left on the surface of the field. Cultivator implements using conventional cultivator tools, like shovels or chisels, are not suited to be used with significant residue on the surface as large amounts of crop residue tend to build up in front of the cultivator tools mounted on the tool shanks.

A method of dealing with surface residue is to use coulter discs, providing vertical cultivation, slicing through the surface residue; however, vertical tillage implements are typically in the form of a dedicated frame which supports the coulter discs thereon such that the discs cannot be retrofit to existing cultivation equipment.

United States Patent Application Publication Nos. 2007/0068688 by Bruce and 2007/0029100 by Tschetter each describe a vertical tillage cultivator formed by retrofitting a cultivator implement with shovel supporting tool shanks thereon, using coulter discs mounted onto the tool shanks in place of the cultivator shovels. Only discs oriented parallel to the forward working direction are shown as each coulter disc supporting assembly uses a simple bearing structure to rotatably support the coulter discs such that the discs can only rotate about respective axes oriented perpendicularly to the forward working direction.

### SUMMARY OF THE INVENTION

According to one aspect of the invention there is provided a coulter disc mounting assembly for a tillage implement including a frame supported for movement across a ground surface in a forward working direction and a plurality of tool shanks supported on the frame, each tool shank having a mounting surface adapted for mounting a respective shovel opener thereon in which the mounting surface has a width which is substantially perpendicular to the forward working direction, the disc mounting assembly comprising:

a hub having a mounting surface for fastening against the mounting surface of one of the tool shanks;

at least one coulter disc rotatably supported on the hub for rotation about a coulter axis;

the hub being arranged to support said at least one coulter disc thereon such that the coulter axis is oriented non-perpendicularly to the forward working direction.

Some embodiments of the invention will now be described in conjunction with the accompanying drawings in which:

### BRIEF DESCRIPTION OF THE DRAWINGS

FIG. 1 is a top plan view of a tillage implement having tool shanks thereon upon which the coulter disc mounting assembly of the present invention is adapted to be mounted;

FIG. 2 is a side elevational view of the tillage implement according to FIG. 1;

FIG. 3 is a front elevational view of one of the tool shanks of the tillage implement according to FIG. 1;

FIG. 4 is a perspective view of a first one of the coulter disc mounting assemblies supported on one of the tool shanks of the tillage implement according to FIG. 1;

FIG. 5 is a perspective view of the first one of the coulter disc mounting assemblies supported on one of the tool shanks of the tillage implement according to FIG. 1;

FIG. 6 is a side elevational view of the first one of the coulter disc mounting assemblies of FIG. 5;

FIG. 7 is a sectional view along the line A-A in FIG. 6;

FIG. 8 is a bottom view of the first one of the coulter disc mounting assemblies of FIG. 5;

FIG. 9 is an exploded perspective view of the first one of the coulter disc mounting assemblies of FIG. 5;

FIG. 10 is a perspective view of a second one of the coulter disc mounting assemblies supported on one of the tool shanks of the tillage implement according to FIG. 1;

FIG. 11 is a side elevational view of the second one of the coulter disc mounting assemblies of FIG. 10;

FIG. 12 is a sectional view along the line A-A of FIG. 11;

FIG. 13 is a bottom view of the second one of the coulter disc mounting assemblies of FIG. 10;

FIG. 14 is a perspective view of a third one of the coulter disc mounting assemblies supported on one of the tool shanks of the tillage implement according to FIG. 1;

FIG. 15 is a bottom view of the third one of the coulter disc mounting assemblies of FIG. 14; and

FIG. 16 is a sectional view similar to the view of FIG. 6, but as an alternative embodiment to the mounting assembly according to any one of FIG. 5, 10, or 14 for mounting against a concave tool shank.

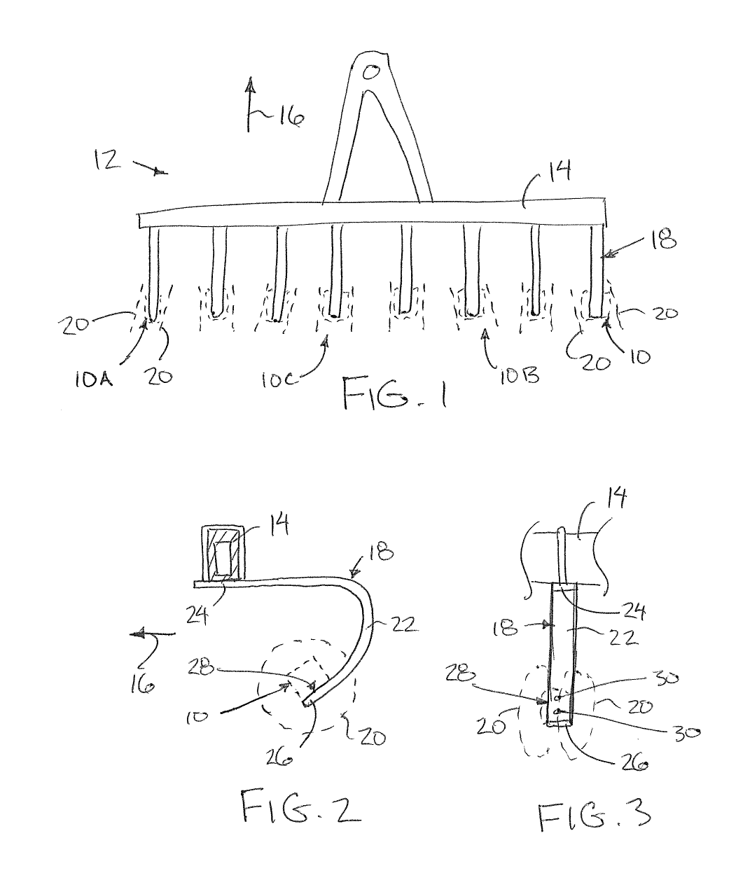

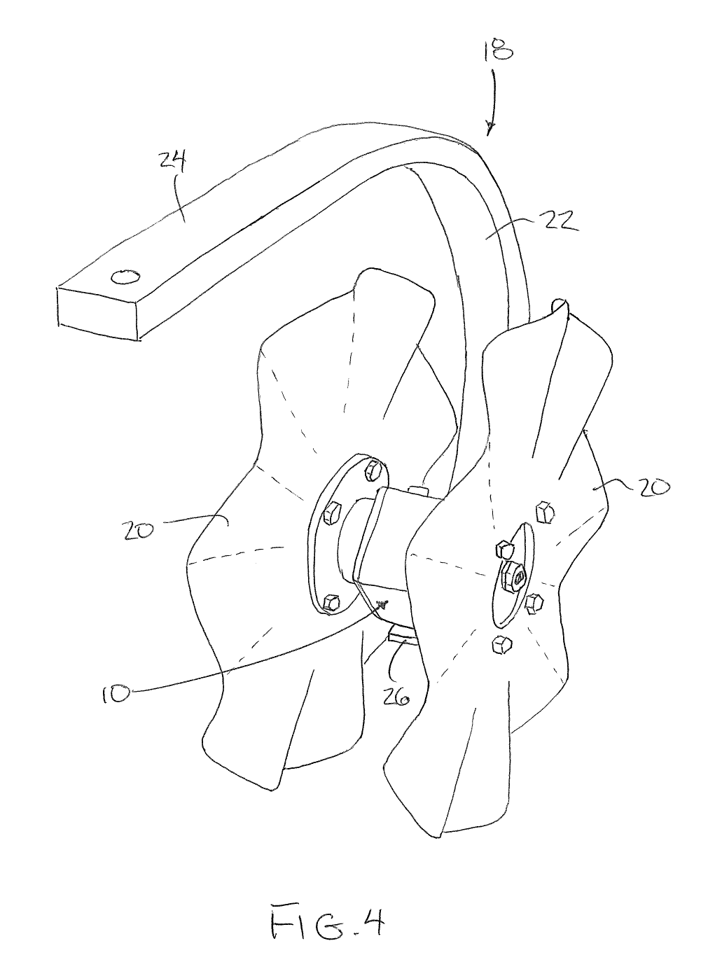

In the drawings like characters of reference indicate corresponding parts in the different figures.

### DETAILED DESCRIPTION

Referring now to the drawings, there is illustrated a coulter disc mounting assembly generally indicated by reference numeral 10. The mounting assembly 10 is used with a tillage implement 12 including a frame 14 for connection to a towing vehicle, for example an agricultural tractor, so as to be supported for movement across a ground surface in a forward working direction 16 of the tractor.

The frame 14 of the tillage implement supports a plurality of tool shanks 18 thereon, in which the tool shanks are each normally used to support a respective one of various types of chisels, shovels, or other related ground working openers thereon. Each mounting assembly 10 is adapted to be mounted on a respective one of the tool shanks in place of a conventional chisel or shovel, for supporting a pair of coulter discs 20 thereon such that the coulter discs lie in an upright plane which is non-parallel and transverse to the forward working direction 16. More particularly, the coulter discs are supported for rotation about a disc axis which is oriented non-perpendicularly to the forward working direction.

In the illustrated embodiment, each tool shank includes a shank arm 22 which is elongate between a top end 24 and a bottom end 26. The top end 24 is mounted on the frame such that the shank arm depends downwardly from the frame for supporting a tool at the bottom end for engagement with the ground. The top end may be resiliently coupled to the frame, or is in the illustrated embodiment, the arm itself may be somewhat resilient to allow some upward and rearward deflection of the bottom end of the arm relative to the frame from a normal relaxed position.

The shank arm 22 typically is shaped to be concave at the leading side thereof such that a portion of the arm adjacent the top end is curved downwardly and rearwardly relative to the frame, whereas a portion of the arm adjacent the bottom end is curved downwardly and forwardly to the bottom end.

A bottom portion of the arm immediately adjacent the bottom end 26 defines a mounting surface 28 at the leading side thereof in which the mounting surface is oriented within a plane extending generally downwardly and forwardly while spanning in a lateral direction of width between opposing side edges of the arm which is substantially perpendicular to the forward working direction. In the illustrated embodiment of the mounting surface is a planar surface, however, in further embodiments, the mounting surface may be concave similar to the curvature of the remainder of the shank arm thereabove.

The shank arms are typically oriented such that a laterally centred line of the arm which defines the path of the arm from the top end to the bottom end thereof lies in a vertical plane which is parallel to the forward working direction.

Each shank arm further includes two mounting holes 30 extending therethrough from the leading side to the trailing side of the arm at spaced apart positions in alignment with the mounting surface 28. The mounting holes are positioned such that an imaginary line connecting between the centre of the two mounting holes lies in a vertical plane parallel to the forward working direction and which is laterally centred relative to the side edges of the arm.

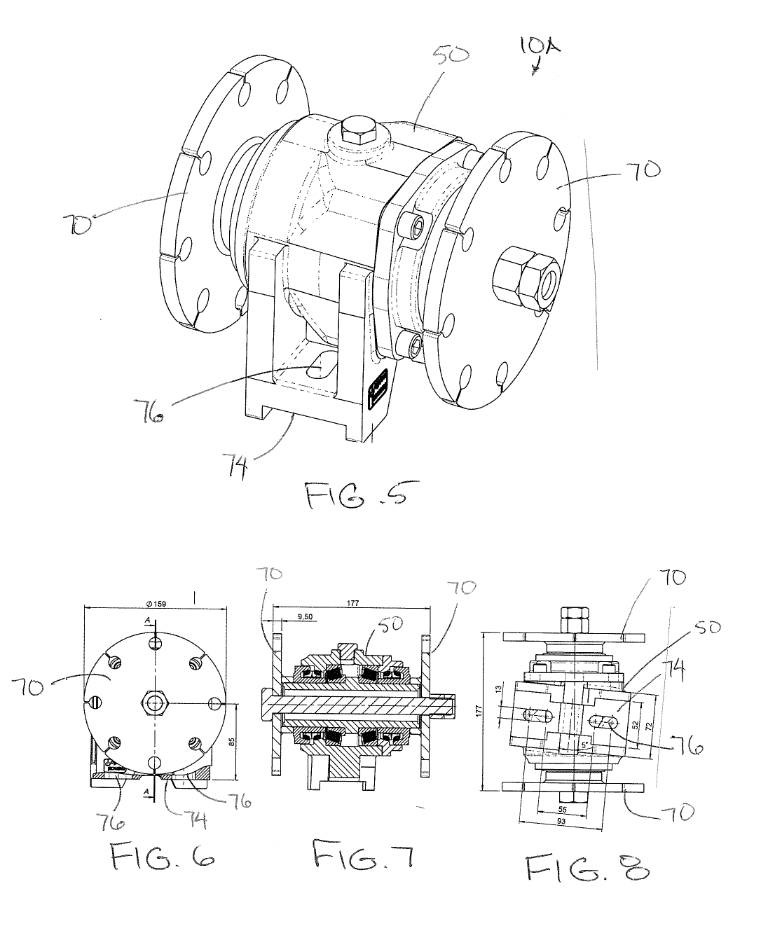

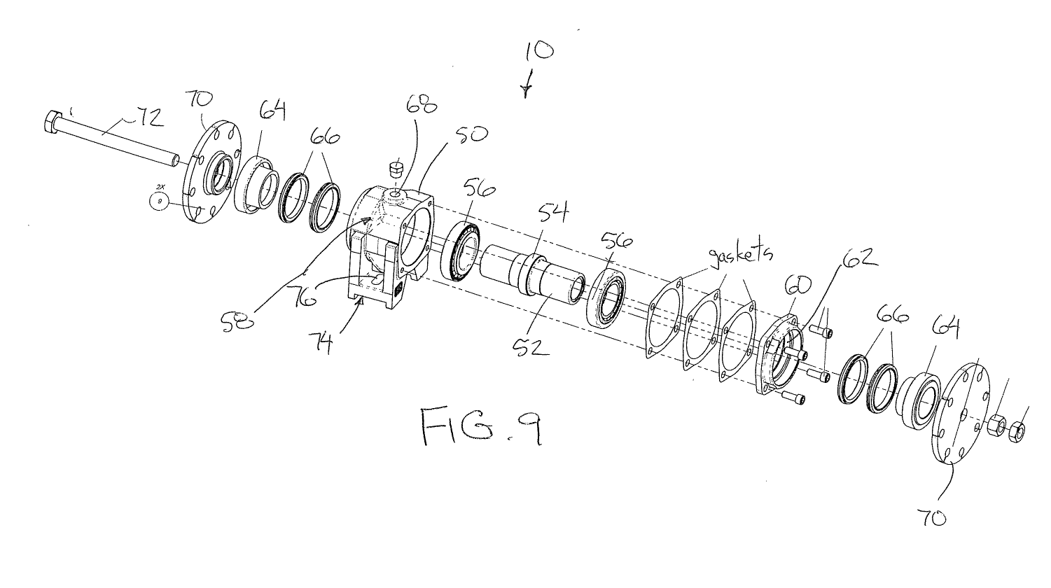

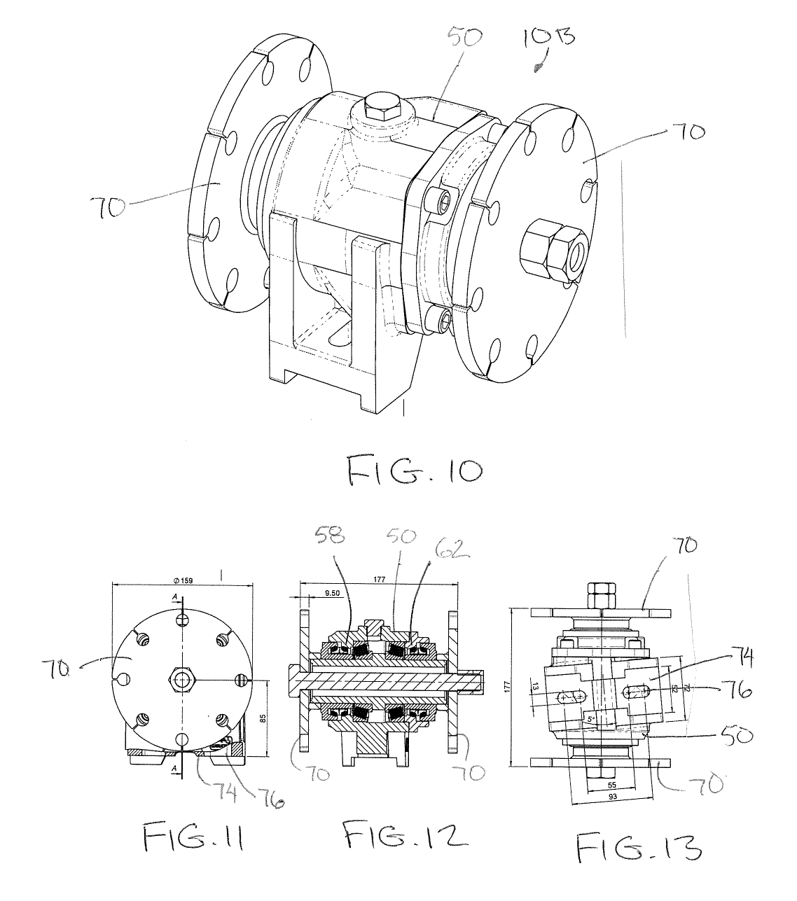

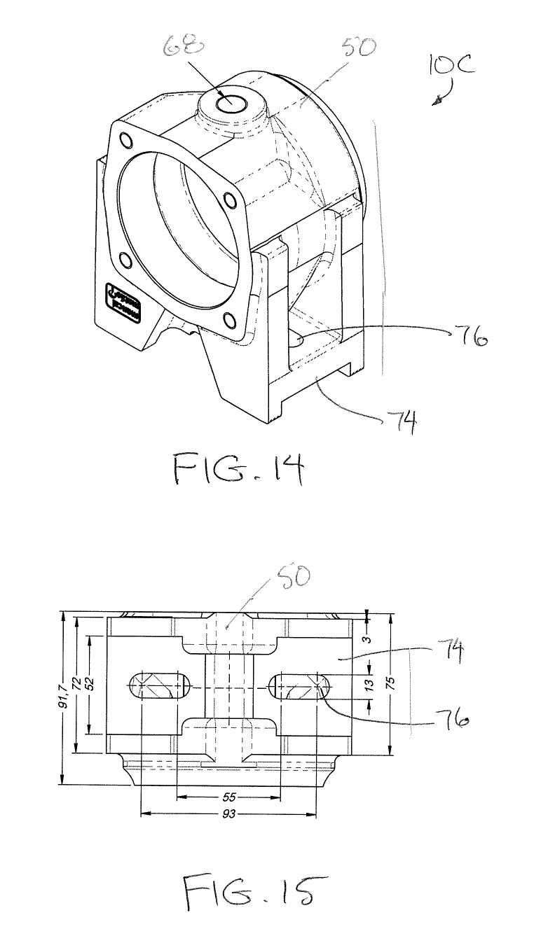

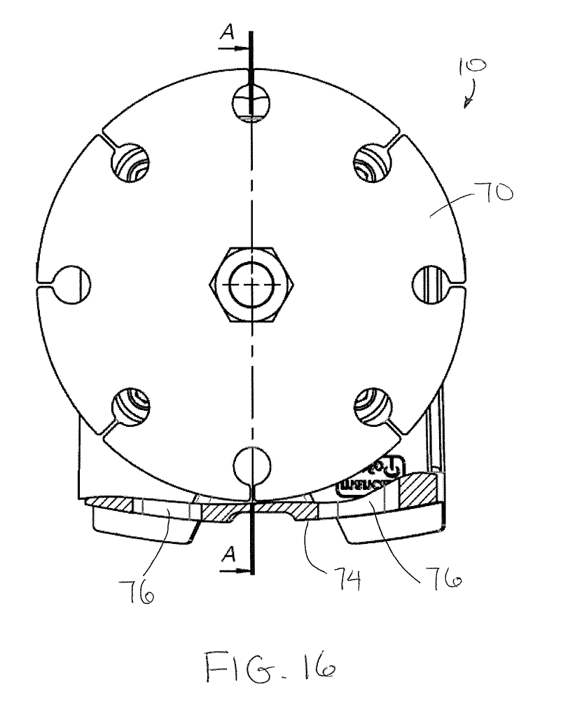

As shown in the accompanying figures, various embodiments of the coulter disc mounting assembly 10 are shown. More particularly the embodiments of FIGS. 4 through 15 are adapted to be mounted on a shank having a planar mounting surface according to the illustrated embodiment. These embodiments include a first angled mounting assembly 10A shown in FIG. 5, a second angled mounting assembly 10B shown in FIG. 10, and a third mounting assembly 10C shown in FIG. 14.

Other assemblies which are identical to the assemblies of FIGS. 5, 10 and 14 respectively are also possible which are modified in the manner of FIG. 16 so as to be adapted for mounting on a tool shank having a concave mounting surface. The assemblies which support coulter discs on tool shanks with concave mounting surfaces would be otherwise identical to the assemblies of FIGS. 5, 10 and 14 respectively.

The features in common with the various embodiments of the mounting assembly 10 will first be described herein.

Each mounting assembly 10 includes a hub 50 comprising a generally cylindrical housing which rotatably supports a shaft 52 therein relative to the tool shank upon which the hub 50 is mounted. The shaft includes a main portion having a first diameter and a central rib 54 which is axially centred between opposing ends of the shaft and which is enlarged in diameter relative to the main portion. The hub 50 has an internal bore having a main portion at an internal diameter greater than the diameter of the central rib 54 of the shaft.

Two annular bearing assemblies 56 support the shaft 52 relative to the surrounding main portion of the hub, in which each annular bearing assembly 56 comprises a ring of tapered bearings in series with one another in the circumferential direction. The two annular bearing assemblies 56 are mounted on opposing sides of the rib 54 to provide radial support between the inner diameter of the main portion of the hub 50 and the outer diameter of the main portion of the shaft 52 while also providing axial support against opposing sides of the rib 54.

To position the annular bearing assemblies 56 in the axial direction, which in turn provides the axial support to the central rib 54, a first rim 58 is provided in fixed relation to the hub to protrude radially inwardly from the main portion of the bore in the hub for abutment against the outer side of one of the annular bearing assemblies 56. A cover plate 60 which is generally annular in shape is selectively fastened to one end of the main hub 50 which defines a second rim 62 protruding inwardly from a main bore through the cover plate which corresponds to the main portion of the bore in the hub 50. The second rim 62 is thus adapted to be positioned in abutment in the axial direction against the outer side of the other annular bearing assembly 56 opposite the first rim 58. Once the cover plate 60 is fixed to the remainder of the hub 50, the two annular bearing assemblies 56 and the central rib 54 therebetween are restricted in the axial direction between the first rim 58 and the second rim 62 so that the tapered bearing assemblies 56 provide axial support to the shaft.

Seal caps 64 are received within the bore in the cover plate 60 and in the bore within the hub 50 at axially opposing ends of the shaft for abutment against outer sides of the two annular bearing assemblies 56. Each seal cap 64 may be pressed onto opposing ends of the shaft for rotation with the shaft while being mounted in sufficiently close tolerance about the outer diameter of the shaft to provide a seal therebetween. Each seal cap includes a suitable recess therein at the inner end for receiving a pair of suitable O-ring seals 66 of resilient material within each cap which forms a seal at the rotating interface between the seal cap secured about the shaft and the surrounding portion of the cover plate 60 or hub 50. In this manner, a sealed chamber is effectively defined between the shaft and the surrounding hub 50 which extends in the axial direction along the shaft between the actually opposed seal caps 64.

A radial port 68 communicates through the hub 50 in the radial direction between an external surface of the hub and the internal sealed chamber for introducing grease or other suitable lubricants into the chamber. A suitable plug can be threaded into the port to selectively close the port once the chamber has been filled with lubricants.

A circular mounting plate 70 is abutted against the outer end face at both ends of the shaft 50. An axial retainer bolt 72 extends fully through the shaft 52 and corresponding mounting apertures in the two mounting plates 70 at the axis of rotation thereof. The retainer bolt 72 includes a head at one end which abuts with the outer surface of one of the mounting plates and is threaded at the opposing end to receive a not thereon which abuts the outer surface of the other one of the mounting plates to effectively clamp the mounting plates to the opposing ends of the shaft.

The mounting plates 70 include circumferentially spaced apart mounting apertures therein to align with corresponding bolt apertures in the coulter discs for bolting the coulter discs to the mounting plates 70 in a conventional manner.

The hub 50 is further shaped to define an external mounting surface 74 on one side of the housing which is oriented generally tangentially to the cylindrical shape of the housing and the main bore therethrough which defines the orientation of the axis of rotation of the shaft and the coulter discs mounted perpendicularly to the axis at opposing ends of the shaft. The mounting surface 74 is formed on a plate-like structure which is fixed centrally to the cylindrical portion of the hub 50 so as to protrude outward in opposing directions which locate respective mounting holes 76 therein which extend fully through the plate-like structure defining the mounting surface so that the mounting holes are generally perpendicular to the mounting surface. The mounting holes are suitably sized and spaced apart for alignment with the corresponding mounting holes 30 within the mounting surface 28 of the shank arm 22. In this manner, the hub 50 is secured to the shank by aligning the mounting surface 74 in parallel abutment against the mounting surface 28 of the shank so that the mounting holes 76 align with the mounting holes 30 to enable threaded fasteners to be penetrated therethrough which fastened the hub to the shank.

Turning now more particularly to the embodiment of FIG. 5, the first angled mounting assembly in this instance is shown with the mounting surface and the two mounting holes therein being positioned relative to the axis of rotation of the shaft such that an imaginary line connected between the centres of the two mounting holes 76 is oriented non-perpendicularly to the axis of rotation, for example at an angle of approximately 85° therebetween. When mounted on an implement having a shank lying generally in a vertical plane oriented in the forward working direction, the resulting coulter axis is non-perpendicular to the forward direction. More particularly, due to the downward and forward inclination of the mounting surface of the shank combined with the angular offset of the non-perpendicular relationship of the imaginary line between the mounting hole 76 and the coulter axis, the coulter axis may be effectively positioned at a compound angle including a first angular offset within a horizontal plane relative to a lateral axis perpendicular to the forward working direction and a second component angularly offset relative to the horizontal plane. In either instance, the hub supports the coulter discs relative to the tool shank such that the coulter axis of rotation of the discs is angularly offset from an imaginary axis at the intersection of a horizontal plane and a plane of the mounting surface of the hub within a range of 2 to 10°, and more particularly approximately 5°.

Turning now more particularly to the embodiment of FIG. 14, the third mounting assembly is shown for use on the implement in combination with the first and second angled mounting assemblies of FIGS. 5 and 10 respectively. The third mounting assembly of FIG. 14 is arranged such that the imaginary line connected between the two mounting holes 76 lies in a vertical plane perpendicular to the coulter axis so that the coulter axis is horizontal and perpendicular to the forward working direction when mounted on the tool shank as described above. The third mounting assembly of FIG. 14 thus defines a neutral orientation for mounting the coulter discs thereon.

Turning now more particularly to the embodiment of FIG. 10, the second angled mounting assembly in this instance is shown with the mounting surface and the two mounting holes therein being positioned relative to the axis of rotation of the shaft such that an imaginary line connected between the centres of the two mounting holes 76 is also oriented non-perpendicularly to the axis of rotation, for example at an angle of approximately 85° therebetween. More particularly, the second angled mounting assembly of FIG. 10 is identical to the embodiment of FIG. 10, with the exception of being offset within a range of 2 to 10°, and more particularly approximately 5°, in an opposing direction from the neutral orientation defined by the hub of FIG. 14 defining the third mounting assembly as compared to the first angled mounting assembly.

When converting conventional tillage implement having tool shanks as described above, into a vertical tillage implement using coulter discs 20, typically a combination of first angled mounting assemblies of FIG. 5, second angled mounting assemblies of FIG. 10 and third mounting assemblies of FIG. 14 are used. The only limitation to the relative number of mounting assemblies is that an even number of first and the second mounting assemblies are typically provided on a single frame to ensure laterally balanced forces being exerted on the frame from the interaction of the coulter discs with the ground to maintain alignment of the frame in the forward working direction.

As described above, if converting a vertical tillage implement having tool shanks with concave mounting surfaces, an identical set of first angled mounting assemblies of FIG. 5, second mounting assemblies of FIG. 10 and third mounting assemblies of FIG. 14 would be used, with the exception of the mounting surfaces of the corresponding mounting assemblies being slightly convex for mating in close abutment with the concave mounting surfaces of the shanks when mounting with fasteners through the corresponding mounting holes, however, alignment of the coulter axis relative to the imaginary line between the mounting surfaces 76 of the hub would remain identical such that a similar combination of angles of the coulter discs relative to the forward working direction would be achieved.

Since various modifications can be made in my invention as herein above described, and many apparently widely different embodiments of same made, it is intended that all matter contained in the accompanying specification shall be interpreted as illustrative only and not in a limiting sense.

1. A coulter disc mounting assembly for a tillage implement including a frame supported for movement across a ground surface in a forward working direction and a plurality of tool shanks supported on the frame, each tool shank having a mounting surface adapted for mounting a respective shovel opener thereon in which the mounting surface has a width which is substantially perpendicular to the forward working direction, the disc mounting assembly comprising:
a hub having a mounting surface for fastening against the mounting surface of one of the tool shanks;
at least one coulter disc rotatably supported on the hub for rotation about a coulter axis;
the hub being arranged to support said at least one coulter disc thereon such that the coulter axis is oriented non-perpendicularly to the forward working direction.

2. The assembly according to claim 1 for a tillage implement in which each tool shank is curved as to lie generally within a vertical plane lying parallel to the forward working direction, wherein the coulter axis is oriented non-perpendicularly to the vertical plane of the respective tool shank.

3. The assembly according to claim 1 wherein the mounting surface of the hub includes two fastener mounting holes for cooperation with two fastener mounting holes on the respective tool shank, and wherein the coulter axis is oriented non-perpendicular to an imaginary line connected between the two fastener mounting holes of the hub.

4. The assembly according to claim 1 wherein the hub is arranged to support said at least one coulter disc thereon such that the coulter axis is angularly offset from an imaginary axis at an intersection of a horizontal plane and a plane of the mounting surface of the hub.

5. The assembly according to claim 4 wherein the coulter axis is offset from the imaginary axis by approximately 5 degrees.

6. The assembly according to claim 4 wherein the angular offset between the coulter axis and the imaginary axis is a compound angle including an angular deviation from the imaginary axis about a central axis which is normal to the mounting surface of the hub.

7. The assembly according to claim 1 wherein the mounting surface of the hub is a planar surface.

8. The assembly according to claim 1 wherein the mounting surface of the hub is a convex surface.

9. The assembly according to claim 1 wherein said at least one coulter disc is mounted on a shaft rotatably supported within the hub by a pair of axially opposed tapered bearing assemblies.

10. A tillage implement comprising:
a frame supported for movement across a ground surface in a forward working direction;
a plurality of tool shanks supported on the frame, in which each tool shank extends downwardly and forwardly so as to lie generally in a respective vertical plane oriented parallel to the forward working direction, and in which each tool shank has a mounting surface at a leading side which is adapted for mounting a respective shovel opener thereon;
a plurality of disc mounting assemblies supported on the tool shanks respectively in which each disc mounting assembly rotatably supports at least one coulter disc thereon for rotation about a coulter axis;
at least some of the disc mounting assemblies comprising an angled disc mounting assembly comprising:
a hub having a mounting surface for fastening against the mounting surface of the respective tool shank and rotatably supporting said at least one coulter disc thereon,
the hub being arranged to supports said at least one coulter disc thereon such that the coulter axis is oriented non-perpendicularly to the vertical plane of the respective tool shank.

11. The implement according to claim 10 wherein each tool shank includes two fastener mounting holes in the mounting surface, and wherein the coulter axis of each angled disc mounting assembly is oriented non-perpendicular to an imaginary line connected between the two fastener mounting holes.

12. The implement according to claim 10 wherein the hub of each angled disc mounting assembly is arranged to support said at least one coulter disc thereon such that the coulter axis is angularly offset from an imaginary axis at an intersection of a horizontal plane and a plane of the mounting surface of the hub.

13. The implement according to claim 12 wherein the coulter axis of each angled disc mounting assembly is offset from the imaginary axis by approximately 5 degrees.

14. The implement according to claim 12 wherein the angular offset between the coulter axis and the imaginary axis of each angled disc mounting assembly is a compound angle including an angular deviation from the imaginary axis about a central axis which is normal to the mounting surface of the hub.

15. The implement according to claim 10 wherein the mounting surface of the hub of each disc mounting assembly is a planar surface.

16. The implement according to claim 10 wherein the mounting surface of the hub of each disc mounting assembly is a convex surface.

17. The implement according to claim 10 wherein the angled disc mounting assemblies include disc mounting assemblies which have respective coulter axes angularly offset in two opposing directions from an axis perpendicular to the vertical plane of the tool shank.

18. The implement according to claim 17 wherein some of the disc mounting assemblies comprise straight disc mounting assemblies in which the coulter axis thereof is perpendicular to the forward working direction.

19. The implement according to claim 10 wherein the coulter axis of each angled disc mounting assembly is offset from an axis perpendicular to the vertical plane of the tool shank by approximately 5 degrees.

20. The implement according to claim 10 wherein said at least one coulter disc of each angled disc mounting assembly is mounted on a shaft rotatably supported within the respective hub by a pair of axially opposed tapered bearing assemblies.
